(19) United States
(12) Patent Application Publication
(10) Pub. No.: US 2015/0365636 A1
(43) Pub. Date: Dec. 17, 2015

(54) VEHICLE PHOTO STUDIO

(71) Applicant: DEALERMADE, Kingwood, TX (US)

(72) Inventor: Brad A. KING, Kingwood, TX (US)

(21) Appl. No.: 14/737,873

(22) Filed: Jun. 12, 2015

Related U.S. Application Data
(60) Provisional application No. 62/011,094, filed on Jun. 12, 2014.

(51) Int. Cl. H04N 7/18; H04N 5/225; H04N 5/235; H04N 5/222

(52) U.S. Cl. CPC H04N 7/185; H04N 5/222; H04N 5/2256; H04N 5/2354; H04N 2101/00

(57) ABSTRACT

A system comprises a platform to rotate a vehicle positioned thereon and at least one fixed camera to generate images of the vehicle as the vehicle is rotated. A local device is in communication with the at least one fixed camera and a remote data storage. A media layer is operable to display the sequential series of still images as a 360 spin view on a remote device.

### CROSS-REFERENCE TO RELATED APPLICATIONS

This application claims priority to U.S. provisional Patent Application Ser. No. 62/011,094 entitled “Vehicle Photo Studio”, which was filed Jun. 12, 2014. This priority application is hereby incorporated herein by reference in its entirety into the present application, to the extent that it is not inconsistent with the present application.

### BACKGROUND

This disclosure relates generally to methods and apparatus for generating still images and videos of a vehicle.

Many vehicle dealerships post their inventory online on the Internet for potential buyers to browse. An important component of this online inventory is images of the vehicles within that inventory. When a new vehicle enters inventory, a photographer usually chooses different views of the new vehicle, and manually uploads these views to a web site. Because this process is manual, this may lead to vehicles in the inventory being presented to the potential buyers in an inconsistent manner. This may lead to potential buyers forming a negative opinion about a vehicle they may have otherwise been interested in purchasing.

In some cases, the photographer may also film a movie of the vehicle to show what the potential buyers would see if they were turning around the vehicle while looking at it, or if they were turning their heads while sitting in the new vehicle. The video files generated in this way may be large, and the files may require an excessive time to be downloaded by the potential buyers that have a small communication bandwidth over the Internet.

Therefore, there is a need to produce and distribute online content that may facilitate marketing of dealership inventories.

### BRIEF SUMMARY OF THE DISCLOSURE

A system comprises a platform to rotate a vehicle positioned thereon and at least one fixed camera to generate images of the vehicle as the vehicle is rotated. A local device is in communication with the at least one fixed camera and a remote data storage. A media layer is operable to display the sequential series of still images as a 360 spin view on a remote device.

In some embodiments the system further comprises a handheld camera. In some embodiments, at least one fixed camera is disposed within the vehicle and the 360 spin view is of an interior of the vehicle. The system may further comprise a studio having two reflective walls and two background walls, wherein the at least one fixed camera is located near a corner of the studio adjacent the two reflective walls and opposite the two background walls. The reflective walls may be colored to deepen colors of a vehicle surface facing downward and lighten colors of a vehicle surface facing upward. The background walls may be colored to define a vehicle outline.

In some embodiments, the system further comprises a studio having lights located above a diffusive ceiling that may be strobe lights. The studio may have lights located adjacent one or more background walls opposite the at least one camera and pointing up toward the platform. In some embodiments, the system may comprise a computer readable medium having instructions stored thereon, wherein the instructions, when executed by the local device, turn the platform, operate the at least one camera, acquire the images from the at least one camera, and transfer the sequential series to the remote data storage.

In some embodiments, a method comprises rotating a platform having a vehicle positioned thereon and generating images of the vehicle from a fixed position as the vehicle is rotated. A sequential series of still images is processed from the generated images and stored on remote data storage. The sequential series is then retrieved from the remote data storage using a remote device and a 360 spin view of the vehicle is displayed on the remote device.

In some embodiments, the method further comprises scanning an identification number of the vehicle and transferring the identification number to the remote data storage. In some embodiments, a local device may control the rotation of the platform and/or the operation of at least one camera to generate the images of the vehicle as the vehicle is rotated. The local device may also synchronize the platform rotation with the generation of images and/or automatically initiate processing the sequential series upon completion of an entire turn of the vehicle. The 360 spin view may shows an exterior or interior of the vehicle.

### BRIEF DESCRIPTION OF THE DRAWINGS

For a more detailed description of the embodiments of the present disclosure, reference will now be made to the accompanying drawings, wherein:

FIG. 1 is partial schematic view of a vehicle photo studio and image processing system; and

FIG. 2 is a flow chart of a method of generating still images representing a 360 spin a vehicle.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

The present disclosure generally describes a system and a process for generating still images for displaying a 360 spin view of a vehicle by positioning the vehicle on a rotating platform and taking images from a fixed position as the vehicle rotates a full 360 degrees. The images are transferred to a local device and then to an online storage facility where they can be accessed by a media layer that can display a catalog view of selected still images of the vehicle and 360 spin view of the vehicle. Therefore, for the purposes of the following description and claims, a “360 spin view” is a series of fixed images that are sequenced and electronically stored in such a manner that allows a user to view the images as a continual rotating view from a fixed location. A 360 spin view may run in a continuous manner so as to appear as a video or may be user controlled so as to appear as a fixed image that can be manipulated to vary the image being viewed.

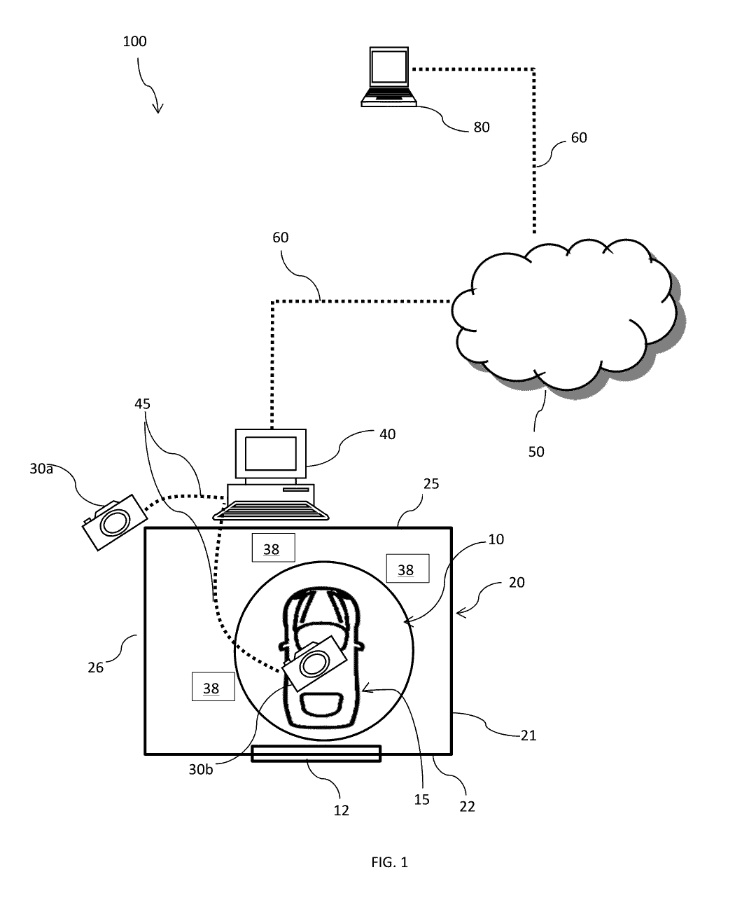

Referring to FIG. 1, the studio system 100 includes a rotating platform 10 positioned within a studio 20 having one or more fixed or stationary cameras 30a, 30b. The studio 20 is constructed of four inside walls, each approximately 24′ to 28′ long and 12′ tall. Two background walls 21 and 22, those opposite the cameras 30a, are painted in light beige or gray to enable outline of light colored and white cars to be clearly defined. The other two reflective walls 25 and 26 are painted medium gray from floor to about 7′ high on the wall and are painted white from about 7′ to about 12′ height on walls. The purpose of the gray and white painted areas may be to deepen the paint color of surfaces of a vehicle 15 facing straight to a downward angle, and lightening surfaces of the vehicle 15 pointing upward to clearly define the curves and lines of the vehicle 15. The ceiling of the studio 20 includes a diffuser made of synthetic fire rated material specifically made for diffusing light.

Ceiling lighting includes fluorescent lights with daylight bulbs (6500 lumens) located above the diffuser and placement within 3′ of the perimeter of the inside walls 21, 22, 25 or 26. Strobe lights 38 located above the diffuser and placement within center positions of the inside walls 21, 22, 25 or 26. Background wall lighting includes lights on the background walls 21 or 22 pointing up the wall and onto the platform 10 for backlit lighting effects. A 12′ wide vinyl power door 12 provides the opening for the vehicle 15 to enter/exit and a standard entry door (not shown) provides access for a photographer.

The rotating platform 10 is an 18′ diameter motorized platform rated at 30,000 lb capacity that is located within the studio 20 with a 5′×8′ ramp (not shown). The rotating platform 10 can alternatively be embedded into a recessed floor built within the concrete floor. The platform 10 may be constructed of 2″×4″ steel beams with ¼″ wall thickness. For example, the platform 10 may include a hub with 8 beams that connect to a 9′ diameter support beam (the inside circular beam) and 24 beams that are connected between the 9′ support beam and an 18′ diameter support beam (the outside circular beam) to create the skeleton of the platform.

The platform 10 may include 4 wheels, each rated at 10,000 lbs capacity, located on the inside 9′ diameter support beam and 8 wheels, each rated at 10,000 lbs capacity, located on the outside 18′ diameter support beam. The wheels ride on ⅛″ thick, 10″ wide flat steel foundation rings located under each support beam. A top plate of the platform 10 that is constructed of diamond plate steel is supported on top of the beams. The top plate may be painted with a powder coating applied by heat treating process to create a durable and reflective surface.

The platform 10 is rotated by an engine including a ¾ horse power motor and a reducer. The shaft of the reducer has a sprocket and chain that connects to a drive wheel that is compressed against the outside circular beam to turn the platform 10. Forward/Reverse, emergency stop, and controls are located outside the studio booth for operation. Alternatively operations of the platform 10 may be automated as further explained below.

One or more exterior cameras 30a (only one is shown) are fixedly mounted within cabinetry in the studio walls and are used to generate images (e.g., take a video) of the exterior of vehicle 15 as it turns on the platform 10. As mentioned before, the exterior cameras 30a are located near a corner of the studio adjacent the two reflective walls 25, 26 and opposite the two background walls 21, 22. One or more interior cameras 30b (only one is shown) are mounted within the vehicle 15 are used to generate images of the interior of vehicle 15 as it turns on the platform 10. One or more of the exterior cameras 30a and/or the interior cameras 30b can also be used to obtain still images of the vehicle 15, i.e. still images zooming on particular features of the vehicle 15. A hand-held camera (not shown) may also be used. The images generated by the cameras 30a, 30b and/or the hand held camera are automatically transferred to a local device 40 via Wi-Fi network 45 or other methods. In certain embodiments, images generated by the cameras 30a, 30b may be transferred directly to remote data storage 50 without processing by the local device 40. The local device 40 may be a local server, personal computer, portable computer, tablet, or other computer device.

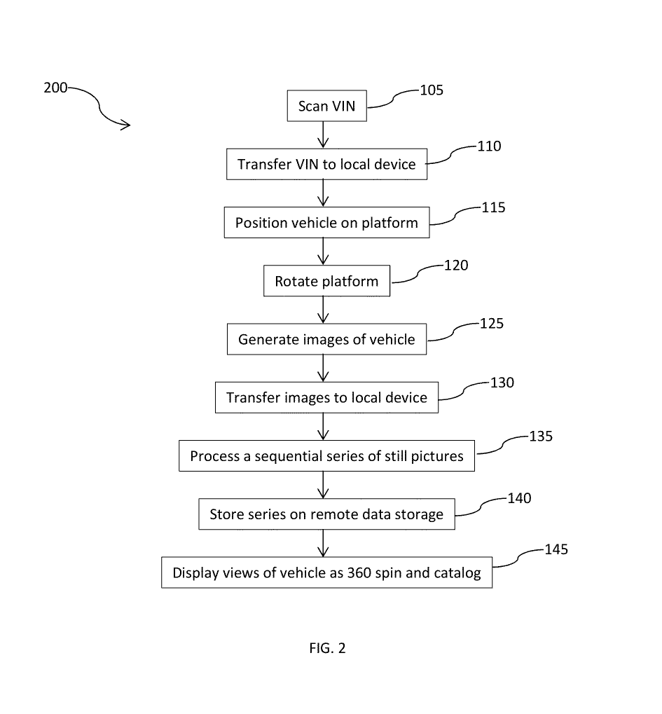

Referring to FIGS. 1 and 2, in step 105 the vehicle identification number (“VIN”) of a vehicle to be imaged can be determined through radio-frequency identification or by using a portable scanner or hand-held camera and then transferred to the local device 40 in step 110. In certain embodiments, the VIN can be selected from an existing list accessible through the local device 40. In certain embodiments, the VIN is transferred to the remote data storage 50, either via the local device 40, directly from another device, or through other means.

The vehicle 15 is positioned on the platform 10 at step 115 and prepared for imaging. As the vehicle completes a complete turn within 1 minute at step 120, the fixed cameras 30a, 30b generates image of the vehicle 15 at step 125, for example the cameras take images of the rotating vehicle. The images are uploaded to the remote data storage 50, at step 130.

Then the still images from both the hand-held, interior and fixed cameras are exported to a remote data storage 50, e.g. to the cloud, via the internet 60 at step 140. At step 145, a media layer 70 embedded into a website allows the still images to be displayed by a remote device 80 as a catalog view and a 360 spin view almost instantly after the still images are stored on the remote data storage 50. As used herein, a catalog view may comprise a table of still images comprising a finite set of selected views of the vehicle 15. The selected views in a catalog may comprise detail images, interior images or exterior images. As used herein, a 360 spin view of the vehicle 15 may comprise a sequential series of still images through which a website visitor can navigate in a forward or reverse manner. The 360 spin view may create a virtually seamless animation of the vehicle rotating. The sequential series of still images may be processed from images generated by an exterior camera and/or an interior camera.

For example, the media layer 70 may run a script that retrieves the still images from the remote data storage 50. Overlays can be applied to the images to insert customer branding within the media layer 70. The still images may be presorted into a first set to be used to form a catalog view and a second set to form a 360 spin view. The media layer 70 is not limited to displaying one catalog view and one 360 spin view of the vehicle 15, and different embodiments may display less or more than one of any of the catalog view and the 360 spin view. The media layer 70 can also accept video that can be displayed within the media layer.

The local device 40 can make the method 200 partially or entirely automated. For example, the local device may pilot the rotating platform 10 and/or operate the cameras 30a, 30b. Upon pressing a “start” button, the local device can operate the studio door 12 to close it, turn the platform 10, operate the cameras 30a, 30b, stop the platform 10, and open the studio door 12. A computer readable medium having instructions stored thereon may be embedded into the local device 40. The instructions, when executed by the local device, cause the local device to automatically turn the platform 10, operate the one or more cameras 30a, 30b, acquire images generated from cameras 30 through the network 45, process a sequential series of still images as further explained below, and transfer the sequential series to a remote data storage 50 via the Internet 60.

While the disclosure is susceptible to various modifications and alternative forms, specific embodiments thereof are shown by way of example in the drawings and description. It should be understood, however, that the drawings and detailed description thereto are not intended to limit the disclosure to the particular form disclosed, but on the contrary, the intention is to cover all modifications, equivalents and alternatives falling within the spirit and scope of the present disclosure.

What is claimed is:

1. A system, comprising:
a platform to rotate a vehicle positioned thereon;
at least one fixed camera to generate a series of sequential still images of the vehicle as the vehicle is rotated;
a local device in communication with the at least one fixed camera and a remote data storage; and
a media layer operable to display the series of sequential still images as a 360 spin view on a remote device.

2. The system of claim 1, further comprising a handheld camera.

3. The system of claim 1, wherein the at least one fixed camera is disposed within the vehicle and the 360 spin view is of an interior of the vehicle.

4. The system of claim 1 further comprising a studio having two reflective walls and two background walls, wherein the at least one fixed camera is located near a corner of the studio adjacent the two reflective walls and opposite the two background walls.

5. The system of claim 4 wherein the reflective walls are colored to deepen colors of a vehicle surface facing downward and lighten colors of a vehicle surface facing upward.

6. The system of claim 4 wherein the background walls are colored to define a vehicle outline.

7. The system of claim 1 further comprising a studio having one or more lights located above a diffusive ceiling.

8. The system of claim 7 wherein the lights are strobe lights.

9. The system of claim 1 further comprising a studio having lights located adjacent one or more background walls opposite the at least one camera and pointing up toward the platform.

10. The system of claim 1 further comprising a computer readable medium having instructions stored thereon, wherein the instructions, when executed by the local device, turn the platform, operate the at least one fixed camera, acquire the images from the at least one camera, and transfer the sequential series to the remote data storage.

11. A method, comprising:
rotating a platform having a vehicle positioned thereon;
generating images of the vehicle from a fixed position as the vehicle is rotated;
storing a sequential series of still images processed from the generated images on remote data storage; and
retrieving the sequential series from the remote data storage using a remote device; and
displaying a 360 spin view of the vehicle on the remote device.

12. The method of claim 11 further comprising:
scanning an identification number of the vehicle; and
transferring the identification number to the remote data storage.

13. The method of claim 11, wherein a local device controls the rotation of the platform.

14. The method of claim 11, wherein a local device operates at least one camera to generate the images of the vehicle as the vehicle is rotated.

15. The method of claim 11, wherein the local device synchronizes the platform rotation with the generation of images.

16. The method of claim 11 wherein the local device automatically initiate processing the sequential series upon completion of an entire turn of the vehicle.

17. The method of claim 11, wherein the 360 spin view shows an exterior of the vehicle.

18. The method of claim 11, wherein the 360 spin view shows an interior of the vehicle.
